(19) United States
(12) Patent Application Publication
(10) Pub. No.: US 2007/0266001 A1
(43) Pub. Date: Nov. 15, 2007

(54) Presentation of duplicate and near duplicate search results

(75) Inventors: Hugh E. Williams, Redmond, WA (US); Ariel J. Lazier, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/430,461

(22) Filed: May 9, 2006

(51) Int. Cl. G06F 17/30

(52) U.S. Cl. 707/2

(57) ABSTRACT

Methods and computer-readable media for sorting and displaying duplicates and near duplicates of a multimedia object. Duplicates and near duplicates of a multimedia object are sorted based on one or more sorting criteria that can offer more efficient and intelligent multimedia searching experiences to users. A representation of all but the most desirable duplicate or near duplicate is initially displayed. An associated annotation is also displayed, indicating that all but the most desirable duplicate or near duplicate.

### STATEMENT REGARDING FEDERALLY SPONSORED RESEARCH OR DEVELOPMENT

Not applicable.

### CROSS-REFERENCE TO RELATED APPLICATIONS

Not applicable.

### BACKGROUND

Search engines provide a way for users to search for various web content. Multimedia search, including search of multimedia objects such as image, audio, or video objects, takes up a rapidly growing part of query traffic that results from Internet searches. Duplicate multimedia objects are highly prevalent on the web. For example, common images such as balls and lines are used on millions of web pages for layout purposes. Another example is celebrity and news pictures. Such pictures are frequently duplicated across news or other information portal sites when articles are syndicated. Still another example is corporate logos that are used throughout each page on corporate web sites.

Presenting duplicates of a multimedia object such as an image or picture in response to a search request is both a difficult and complicated task. Duplicates of an image, for instance, may be saved in different formats, at different resolutions, or with minor edits using graphical techniques such as cropping and rotation. Multiple web sites may contain duplicates and near duplicates for the same or different purposes. Current search engines, however, are often unable to identify and sort through such duplicates to provide more efficient and intelligent presentation to users. Therefore, users are often forced to wait until a search request returns such duplicates when in fact most of the duplicates are indistinguishable from one another. For example, when a user searches for a popular multimedia object such as an image of the user's favorite movie star, a search engine would return a slew of hyperlinks or other type of links of images containing the pictures of the movie star. Most of the images, however, are likely to be duplicates or near duplicates of each other. The user has to download and view each of the images one at a time until the user finds an image having acceptable clarity and resolution. Some of the images may be downloaded from a web site server that is located within just few miles of the user's residence. Some other images, however, may have to travel half way around the globe to reach the user. The images may be available in JPG, TIFF, PDF, GIF, or in other numerous image file types. The duplicate images may contain pictures having excessively high or terribly low resolutions for the user. Frequently, therefore, the user may have to spend a great amount of time before identifying a duplicate having acceptable clarity and resolution that is saved in the user's favorite image file type. Therefore, a user's ability to perform a search for a desired multimedia object may be significantly limited by the scarcity of time as well as the limited bandwidth that is clogged by duplicates and near duplicates that offer little or no distinct alternative to the user.

### SUMMARY

Embodiments of the present invention provide methods for sorting and displaying duplicates and near duplicates of a multimedia object. In one embodiment, duplicates and near duplicates of a multimedia object are sorted to determine the most desirable duplicate or near duplicate. Only a representation of the most desirable duplicate or near duplicate is initially displayed. The remaining duplicates and near duplicates are initially hidden from a user's view and an annotation is displayed instead, indicating that the remaining duplicates and near duplicates are available to the user.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a flow chart of a method for displaying duplicates and near duplicates of a multimedia object, according to embodiments of the present invention;

FIGS. 3A-C are diagrams for presenting duplicates and near duplicates of a multimedia object, according to embodiments of the present invention;

FIG. 4 is a flow chart of a method for sorting duplicates and near duplicates of a multimedia object having an equal rank, according to embodiments of the present invention;

FIG. 5 is a flow chart of a method for sorting duplicates and near duplicates of a multimedia object using more than one sorting criterion, according to embodiments of the present invention; and

FIG. 6 is a flow chart of a method for sorting duplicates and near duplicates of a multimedia object using user-provided inputs, according to embodiments of the present invention.

### DETAILED DESCRIPTION

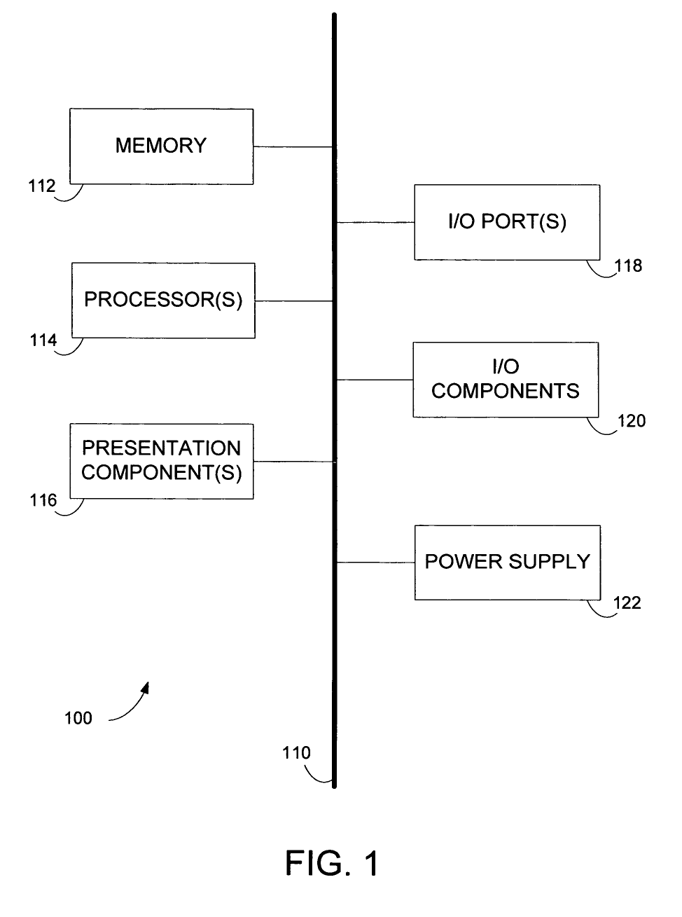

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network. In a distributed-computing environment, program modules may be located in both local and remote computer-storage media including memory-storage devices. The computer-useable instructions form an interface to allow a computer to react according to a source of input. The instructions cooperate with other code segments to initiate a variety of tasks in response to data received in conjunction with the source of the received data.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an 110 component. Also, processors have memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

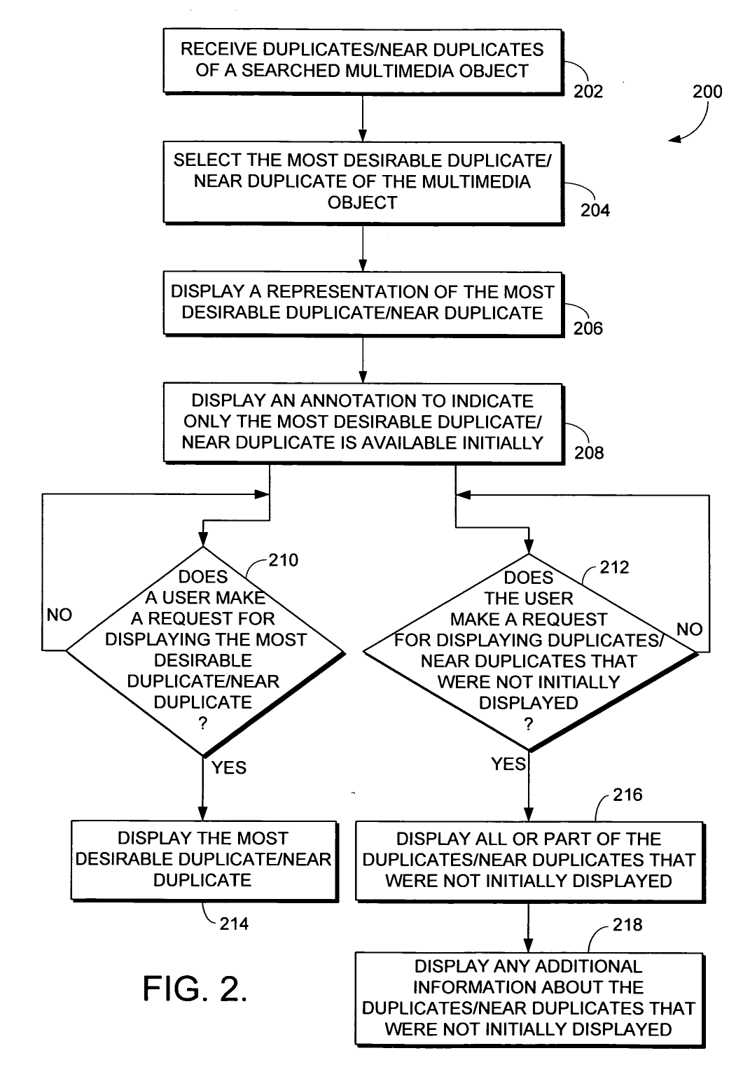

FIG. 2 is a flow chart of a method for displaying duplicates and near duplicates of a multimedia object, according to embodiments of the present invention. FIG. 2 illustrates a method 200 for displaying duplicates and near duplicates of a multimedia object. Method 200 begins at operation 202, where duplicates and near duplicates of a multimedia object that result from a search are received. In one embodiment, the duplicates and near duplicates are not in any particular order that may be useful for determining the most desirable duplicate or near duplicate. In operation 204, the most desirable duplicate or near duplicate of the multimedia object is selected after the duplicates and near duplicates are sorted based on at least one set of sorting criteria. In one embodiment, the sorting criteria comprises the multimedia file type popularity, geographical distance from the user, destination page or site quality, and a display dimension such as image resolutions. However, embodiments are not limited to any combination of sorting criterion. Once the most desirable duplicate or near duplicate is selected, in operation 206, a representation of the selected duplicate is displayed. In one embodiment, the selected duplicate or near duplicate may be represented as a thumbnail image if the multimedia object is an image or a picture. In another embodiment, the selected duplicate or near duplicate may be represented as an audio summary that plays a brief sample of a musical composition or a song if the multimedia object is an audio object such as a MP3 file that contains a popular song or a classical composition. In another embodiment, the duplicate or near duplicate may also be represented as a video summary that can play a short preview or display first few frames if the multimedia object is a video object such as a movie clip. Embodiments of the present invention are not limited to any particular representation.

In operation 208, an annotation is displayed to indicate that there are more duplicates and near duplicates for users to view. In embodiments, the annotation may be displayed in the form of text, an icon, an image, or a combination thereof that is capable of informing the users. For instance, an icon with a plus sign inside a small square box may be used to indicate that there is a list of more duplicates and near duplicates that may become visible if the icon is expanded. However, embodiments are not limited to any particular annotation. Once the representation of the selected duplicate and the annotation are displayed, a user may choose to open the most desirable duplicate or near duplicate by making a request. For example, the most desirable duplicate or near duplicate may be displayed when the user double-clicks the representation. The user may also choose to view remaining duplicates and near duplicates that are initially hidden. For example, the remaining duplicates and near duplicates may be displayed when the user double clicks the annotation. In operation 210, it is determined whether the user has made a request for displaying the most desirable duplicate or near duplicate. If the user has made such request, the selected most desirable duplicate or near duplicate is displayed in operation 214. In operation 212, it is determined whether the user has made a request for displaying the initially hidden duplicates and near duplicates. If the user has made the request, all or parts of the hidden duplicates and near duplicates are displayed in operation 216. Any additional information that is associated with the hidden duplicates and near duplicates is also displayed in operation 218.

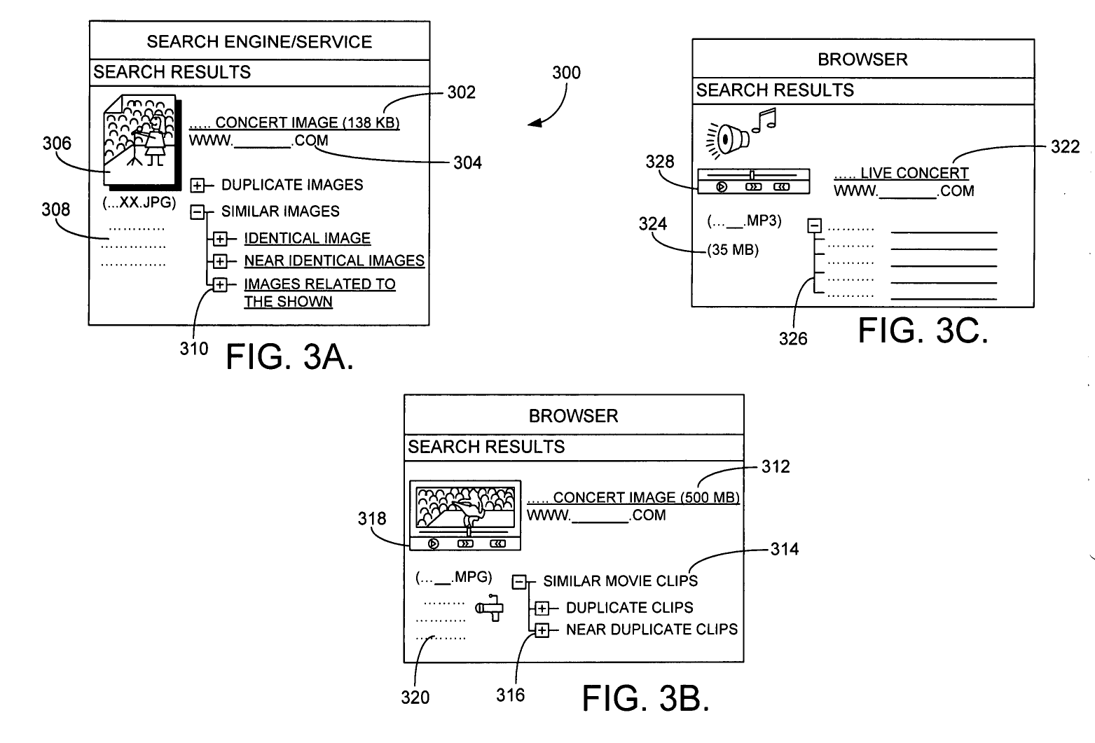

FIGS.3A-C are diagrams for presenting duplicates and near duplicates of a multimedia object, according to embodiments of present invention. More specifically, FIGS. 3A-C illustrate diagrams for initial and subsequent displaying of duplicates and near duplicates of multimedia objects, their representations, the annotations, and other pertinent information. FIG. 3A illustrates one embodiment of a displaying environment for duplicates and near duplicates of a visual object, such as an image. However, embodiments are not limited to an image, as any other multimedia object may be the visual object. In one embodiment, only a thumbnail image 306 of a most desirable duplicate or near duplicate is displayed along with an iconic annotation 310 that indicates to a user that more duplicates and near duplicates are available if the user expands the list of initially hidden duplicates and near duplicates. In one embodiment, more detailed information that is pertinent to the most desirable duplicate may be displayed along with the associated representation and the annotation. Such detailed information may comprise the size 302 of the actual duplicate image, an identification 304 of the site from which the most desirable duplicate was retrieved, and other useful information 308, such as an article that is associated with the most desirable duplicate. However, embodiments are not limited to any particular display arrangement or contents.

FIG. 3B illustrates how an embodiment of a displaying environment may look when a user makes a request to display the most desirable duplicate of a movie clip. The most desirable duplicate 318 of a movie clip is presented for the user. A textual annotation 314 is displayed together with an icon 316 to indicate to the user that more duplicates and near duplicates of the movie clip may become available when the user makes a request. In one embodiment, more detailed information that is pertinent to the most desirable duplicate of the movie clip may be displayed along with the annotation. In one embodiment, such information comprises the size 312 of the movie clip and other pertinent information such as a commentary or ratings 320 given to the movie clip by other viewers. Embodiments are not limited to the particular display arrangement or contents illustrated in FIG. 3B.

FIG. 3C illustrates how one embodiment of a displaying environment may look when a user makes a request to display other initially hidden duplicates and near duplicates. In one embodiment, the most desirable duplicate of an audio object is represented by an audio summary 328 and accompanies pertinent information such as the size 324 of the duplicate and an identification of the site 322 from which the most desirable duplicate was retrieved. In one embodiment, hidden duplicates and near duplicates are displayed in list 326 when the user expands the list. In one embodiment, the list may comprise hyperlinks that are associated with the initially hidden duplicates and near duplicates. The list may also comprise audio summaries of the hidden duplicates and near duplicates. Embodiments are not limited to the particular display arrangement or contents illustrated in FIG. 3C.

Advantageously, embodiments of the present invention allow for more efficient and flexible display environments. A user is initially presented with a representation of the most desirable duplicate or near duplicate of a multimedia object such as a thumbnail image, audio summary, or video summary. The user, however, may expand the initial display by making a request to download the most desirable duplicate or near duplicate and play or view the duplicate if the representation of the duplicate was interesting enough to attract the user's attention. The user may also go beyond the initial presentation of the most desirable duplicate or near duplicate to select from duplicates and near duplicates that were initially hidden from the user. The user can be, thereby, spared from downloading one image or video clip after another until the user encounters a duplicate that fits the user's preference or purpose.

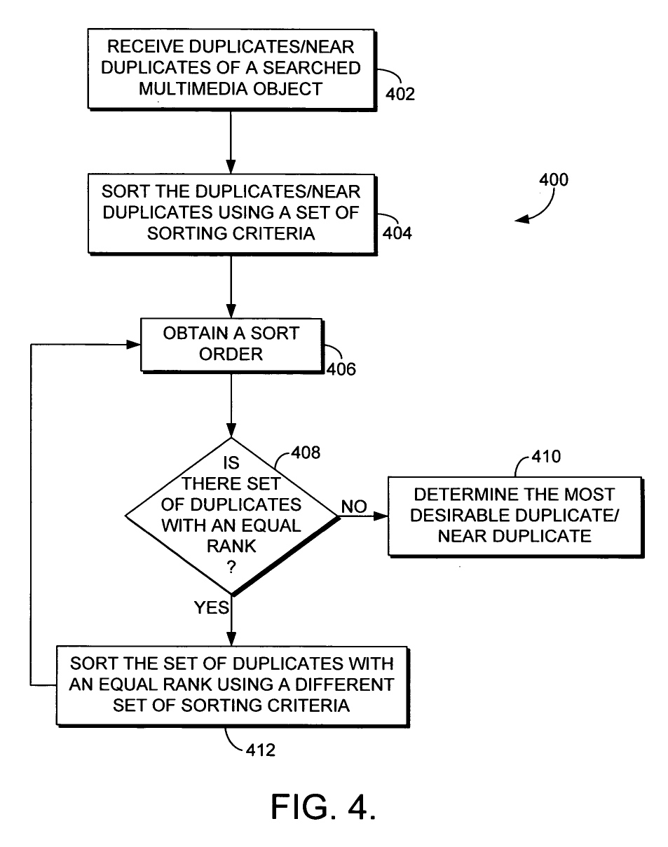

FIG. 4 is a flow chart of a method for sorting duplicates and near duplicates of a multimedia object having an equal rank, according to embodiments of the present invention. FIG. 4 illustrates a method 400 for sorting a set of duplicates and near duplicates that have an equal rank after all the duplicates and near duplicates have been earlier sorted using a set of sorting criteria. In operation 402, duplicates and near duplicates of a multimedia object that result from a search are received. In one embodiment, the duplicates and near duplicates are not in any particular order that may be useful for determining the most desirable duplicate or near duplicate. In operation 404, the duplicates and near duplicates are sorted based on a set of sorting criteria. In one embodiment, the set of criteria comprises the geographic distance from the user, a display dimension such as image resolutions, the file type popularity, the destination page or site quality, or any combination thereof. Embodiments are not limited to any particular sorting criteria. In operation 406, a sort order resulting from the initial sorting is obtained. In operation 408, the resulting sort order is inspected to determine whether there is a set of duplicates and near duplicates that are assigned an identical rank within the resulting order. If there is no such set of duplicates and near duplicates, then the most desirable duplicate is selected from the resulting sort order in operation 410. If, however, there is a set of duplicates and near duplicates that share an identical rank, then only that set of duplicates and near duplicates is sorted again using a different set of sorting criteria to assign a different rank to each of the duplicates and near duplicates in operation 412. Operations 406, 408, 410, and 412 are repeated until there is no set of duplicates and near duplicates that share an identical rank.

In one embodiment, method 400 advantageously assigns a distinct rank to each of the duplicates and near duplicates for orderly display. Assigning a distinct rank to each of the duplicates and near duplicates is also important because the method 400 may not be able to display all of the duplicates and near duplicates. This is beneficial because there could be, for instance, tens of thousands of duplicate and near duplicate images of a popular singer or movie star.

In one embodiment, the method 400 advantageously sorts a set of randomly ordered duplicates and near duplicates of a multimedia object using sorting criteria to rearrange such duplicate and near duplicates, thereby bringing a faster and more efficient multimedia search experiences to users. By sorting duplicates and near duplicates of a video object having a considerable file size, for example, using the geographic distance from the user as the sole sorting criterion or in combination with other sorting criteria, the method 400 can present the most desirable duplicate that can be downloaded faster. The geographic distance between the user and the location of the server for the site from which the most desirable duplicate was retrieved is used to determine the ranks of the resulting sort order to the user's advantage. Also, by sorting duplicates and near duplicates of an image using file type popularity, the method 400 can present a number of useful advantages to a user. For example, an image object that is saved in GIF format may be easier to download because its file size to resolution ratio may be better than other image object formats. The same image captured in JPG format, on the other hand, may be better if the user intends to attach the image to the outgoing emails or to print out multiple copies of the image using a printer because it may be a more acceptable format for printing devices and for network transmissions.

In another embodiment, the method advantageously sorts a set of randomly ordered duplicates and near duplicates of a multimedia object using a set of sorting criteria that comprises the destination page or site quality and a display dimension such as image resolutions. By sorting the randomly arranged duplicates and near duplicates based on the destination page or site quality, a user can gain access to more recently produced near duplicates of the multimedia object. For example, news sites of CNN and NBC are more likely to update their site contents more frequently than other sites. Also, by sorting the randomly arranged duplicates and near duplicates based on image resolutions, the user can save time downloading a multimedia object such as an image or video file by avoiding objects having excessively high resolutions that may not be suitable for non-commercial use or personal enjoyment. Embodiments of the present invention are not limited to any particular sorting criteria.

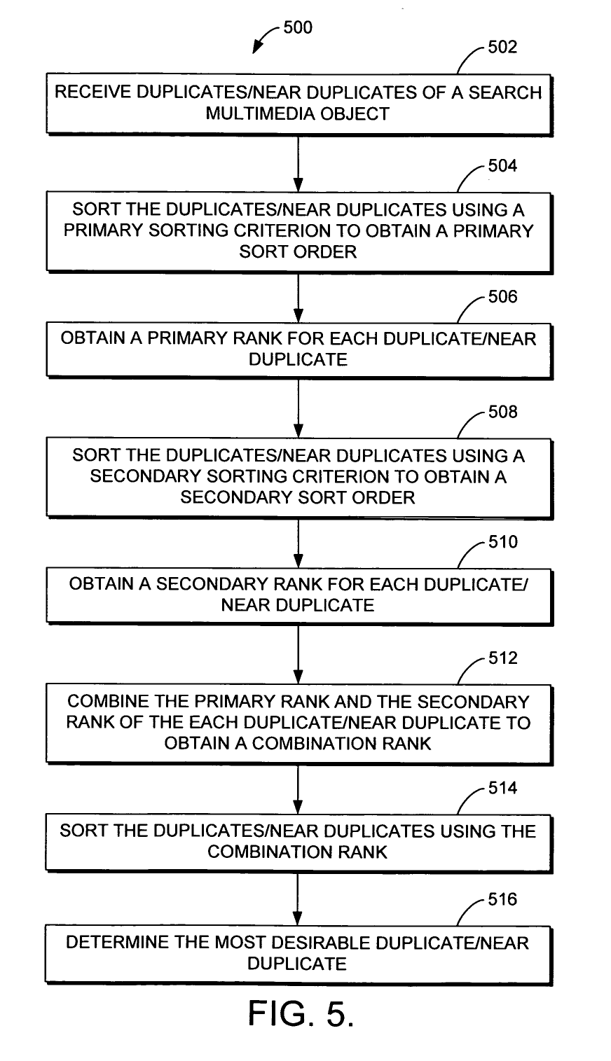

FIG. 5 is a flow chart of a method for sorting duplicates and near duplicates of a multimedia object using more than one sorting criterion, according to embodiments of the present invention. FIG. 5 illustrates a method 500 for sorting duplicates and near duplicates of a multimedia object based on at least two different sorting criteria and combining the resulting ranks to determine the most desirable duplicate or near duplicate. In operation 502, duplicates and near duplicates of a multimedia object that result from a search are received. In operation 504, the duplicates and near duplicates are sorted using a primary sorting criterion to obtain a primary sort order. For example, if the duplicates and near duplicates are sorted based on geographic distance from the user as the primary sorting criterion, each of the duplicates and near duplicates would be rearranged in accordance with the distance between its originating server and the user. This new arrangement is referred to as primary sort order. Next in operation 506, each of the duplicates and near duplicates in the primary sort order is assigned a primary rank. For instance, if a user residing in Kansas City searches for an image, a duplicate or near duplicate of the image that originates from a server located in Des Moines would attain higher rank than ones originated from a server located in New York or Boston within the primary sort order. In operation 508, the duplicates and near duplicates in the initial arrangement are sorted again now with a secondary sorting criterion such as file type popularity to obtain a secondary sort order. In operation 510, each of the duplicates and near duplicates in the secondary sort order is assigned a secondary rank. For instance, a duplicate or near duplicate of an image file that is saved in JPG format would attain higher rank than ones that are saved in GIF format if JPG format is more popular than GIF format. In operation 512, the primary rank and the secondary rank of each of the duplicates and near duplicates are combined to obtain a combination rank. In an embodiment, the primary rank and secondary rank can be combined using any mathematical operation, including simple operations such as addition, subtraction, multiplication, and division, as well as more complex algorithms such as, but not limited to, linear and quadratic equations. In one embodiment, for example, the primary rank and the secondary rank of the duplicates and near duplicates are added to obtain a combination rank. For instance, if one duplicate or near duplicate of a multimedia object is ranked second in the primary sort order and fifth in the secondary sort order and another duplicate or near duplicate is ranked third in the primary sort order and third in the secondary sort order, the later would attain higher combination rank than the former because the later obtains smaller number (6) than the number obtained by the former (7). In operation 514, the duplicates and near duplicates are sorted again based on the combination rank to obtain a resulting combination sort order. In operation 516, the most desirable duplicate or near duplicate is determined from the combination sort order.

In one embodiment, operation 506 may be implemented by multiplying a primary weighting factor to each rank of the primary sort order to obtain the primary rank. In one embodiment, operation 510 can be similarly implemented by multiplying a secondary weighting factor to each rank of the secondary sort order to obtain the secondary rank. For example, suppose that the geographic distance from a user is used as a primary sorting criterion that is associated with a primary weighting factor of five (5) and the file type popularity is used as a secondary sorting criterion that is associated with a secondary weighting factor of two (2). If a particular duplicate or near duplicate of a multimedia object is ranked second (2) within the primary sort order and sixth (6) within the secondary sort order, the combination rank of the particular duplicate or near duplicate can be calculated by multiplying the primary weighting factor (5) by the primary rank (2), multiplying the secondary weighting factor (2) by the secondary rank (6), and adding the two products. The method may also employ other algorithms for producing a similar linear combination. The method may also employ a tertiary sorting criterion and a quadratic sorting criterion or beyond if necessary.

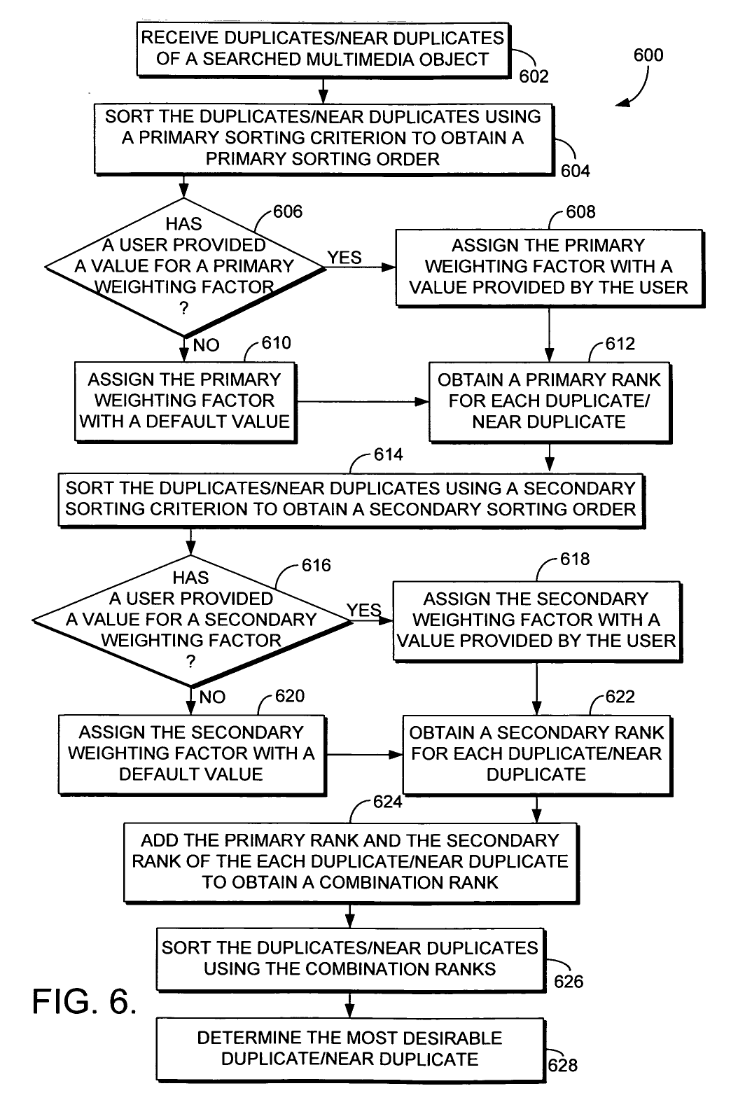

FIG. 6 is a flow chart of a method for sorting duplicates and near duplicates of a multimedia object using user-provided inputs, according to embodiments of the present invention. FIG. 6 illustrates a method 600 for sorting duplicates and near duplicates of a multimedia object using at least two different sorting criteria with a weighting factor that is set by a user. However, embodiments are not limited to any number of sorting criteria. After receiving duplicates and near duplicates of a multimedia object that result from a search in operation 602, the duplicates and near duplicates are sorted using a primary sorting criterion to obtain a primary sort order in operation 604. In one embodiment, the user is given an opportunity to set a value for a primary weighting factor. For example, a dialog window may pop up to ask for a value to be used as the primary weighting factor. In operation 606, it is determined whether the user has provided a value for the primary weighting factor. If the user has provided a desired value, the value set by the user is assigned to the primary weighting factor in operation 608. If the user has not provided a value, a default value is assigned to the primary weighting factor in operation 610. For instance, a system default value may be already pre-assigned to the primary weighting factor and may be overridden only when a user provides a substituting value. Once the primary weighting factor is determined, primary ranks are obtained and assigned to the duplicates and near duplicates within the primary sorting order in operation 612. In one embodiment, the primary ranks may be obtained in operation 612 by multiplying the primary weighting factor to the ranks within the primary sort order. For instance, if the value of the primary weighting factor is set as five (5), the primary rank of a duplicate or near duplicate of an image object that is ranked second (2) within the primary sort order can be obtained by multiplying the primary weighting factor (5) by the rank within the primary sort order (2).

In operation 614, the duplicates and near duplicates are sorted again using a secondary sorting criterion to obtain a secondary sort order. In one embodiment, the user is given an opportunity to set a value for a secondary weighting factor to obtain a secondary sorting order. For example, a popup window or a dialog box may be used to ask for a value to be used as the secondary weighting factor. Operation 616 determines whether the user has provided a value for the secondary weighting factor. If the user has provided a desired value, the value set by the user is assigned to the secondary weighting factor in operation 618. Otherwise, a default value is assigned to the secondary weighting factor in operation 620. For instance, a system default value may be already pre-assigned to the secondary weighting factor and may be overridden only when a user provides a desired value. Once the secondary weighting factor is properly assigned, secondary ranks are obtained and assigned to the duplicates and near duplicates within the secondary sort order in operation 622. In one embodiment, the secondary ranks may be obtained in operation 622 by multiplying the secondary weighting factor to the ranks within the secondary sort order. For example, if the value of the secondary weighting factor is set as seven (7), the secondary rank of a duplicate or near duplicate of an image object that is ranked third (3) within the secondary sort order can be obtained by multiplying the secondary weighting factor (7) by the rank within the secondary sort order (3).

In one embodiment, once the primary and the secondary ranks are properly obtained for the duplicates and near duplicates, the primary rank and secondary rank of each of the duplicates and near duplicates are added to obtain a combination rank for each of the duplicates and near duplicates in operation 624. In operation 626, the duplicates and near duplicates are rearranged using the combination rank to obtain a combination order. The most desirable duplicate or near duplicate is then determined from the combination order in operation 628.

In one embodiment, the method 600 advantageously offers a user an opportunity to customize the weighting factors such that the user can tailor the resulting presentation of duplicates and near duplicates of a multimedia object to the user's preference or a particular purpose. At the same time, the method 600 also offers a degree of flexibility to the user by providing a default value if the user intentionally or mistakenly fails to provide a desired value to be assigned to the weighting factors.

A method for presenting multimedia search results to a user comprises: after a most desirable duplicate or near duplicate from a plurality of duplicates or near duplicates of a multimedia object that is available to a user has been determined, displaying a representation of the most desirable duplicate or near duplicate to the user; initially hiding all but the most desirable duplicate or near duplicate of the plurality of duplicates or near duplicates from the user; and displaying an annotation indicating that all but the most desirable duplicate or near duplicate of the plurality of duplicates or near duplicates are available to the user.

A method of creating a web page to present multimedia search results to a user comprises: after a most desirable duplicate or near duplicate from a plurality of duplicates or near duplicates of a multimedia object that is available to a user has been determined, coding a web page to display a representation of the most desirable duplicate or near duplicate to the user; coding the web page to initially hide all but the most desirable duplicate or near duplicate of the plurality of duplicates or near duplicates from the user; and coding the web page to display an annotation indicating that all but the most desirable duplicate or near duplicate of the plurality of duplicates or near duplicates are available to the user.

A method of sorting multimedia search results, comprises: after a plurality of duplicates or near duplicates of a multimedia object that is available to a user has been determined, sorting the plurality of duplicates or near duplicates using a first set of sorting criteria to obtain a sort order; and determining a most desirable duplicate or near duplicate from the sort order, wherein the multimedia object is an image, an audio object, or a video object.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The invention claimed is:

1. A method for presenting multimedia search results to a user, comprising:
after a most desirable duplicate or near duplicate from a plurality of duplicates or near duplicates of a multimedia object that is available to a user has been determined, displaying a representation of the most desirable duplicate or near duplicate to the user;
initially hiding all but the most desirable duplicate or near duplicate of the plurality of duplicates or near duplicates from the user; and
displaying an annotation indicating that all but the most desirable duplicate or near duplicate of the plurality of duplicates or near duplicates are available to the user.

2. The method of claim 1, wherein the multimedia object is an image, an audio object, or a video object.

3. The method of claim 1,
wherein the representation is a thumbnail image, an audio summary, or a video summary, and
wherein the annotation is text, an image, or an icon.

4. The method of claim 1, wherein the most desirable duplicate or near duplicate is determined based on geographic distance from the user, display dimensions, file type popularity, destination page quality, or a combination thereof.

5. The method of claim 1, further comprising:
displaying the most desirable duplicate or near duplicate in response to a request from the user.

6. The method of claim 1, further comprising:
displaying at least one of the plurality of duplicates or near duplicates that were not initially displayed in response to a request from the user; and
displaying additional information about the at least one of the plurality of duplicates or near duplicates that were not initially displayed.

7. A computer-readable medium having computer-executable instructions for performing the operations recited in claim 1.

8. A method of creating a web page to present multimedia search results to a user, comprising:
after a most desirable duplicate or near duplicate from a plurality of duplicates or near duplicates of a multimedia object that is available to a user has been determined, coding a web page to display a representation of the most desirable duplicate or near duplicate to the user;
coding the web page to initially hide all but the most desirable duplicate or near duplicate of the plurality of duplicates or near duplicates from the user; and
coding the web page to display an annotation indicating that all but the most desirable duplicate or near duplicate of the plurality of duplicates or near duplicates are available to the user.

9. The method of claim 8, wherein the multimedia object is an image, an audio object, or a video object.

10. The method of claim 8,
wherein the representation is a thumbnail image, an audio summary, or a video summary, and
wherein the annotation is text, an image, or an icon.

11. The method of claim 8, wherein the most desirable duplicate or near duplicate is determined based on geographic distance from the user, display dimensions, file type popularity, destination page quality, or a combination thereof.

12. The method of claim 8, further comprising:
coding the web page to display at least one of the plurality of duplicates or near duplicates that were not initially displayed in response to a request from the user; and
coding the web page to display additional information about the at least one of the plurality of duplicates or near duplicates that were not initially displayed.

13. The method of claim 8, further comprising:
coding the web page to display the most desirable duplicate or near duplicate in response to a request from the user.

14. A computer-readable medium having computer-executable instructions for performing the operations recited in claim 8.

15. A method of sorting multimedia search results, comprising:
after a plurality of duplicates or near duplicates of a multimedia object that is available to a user has been determined, sorting the plurality of duplicates or near duplicates using a first set of sorting criteria to obtain a sort order; and
determining a most desirable duplicate or near duplicate from the sort order, wherein the multimedia object is an image, an audio object, or a video object.

16. The method of claim 15, wherein the first set of sorting criteria comprises geographic distance from the user, display dimensions, file type popularity, destination page quality, or a combination thereof.

17. The method of claim 15, further comprising:
if the sort order has at least one set of duplicates or near duplicates of the multimedia object with an equal rank, using a second set of sorting criteria to sort the at least one set of duplicates or near duplicates.

18. The method of claim 17,
wherein the second set of sorting criteria comprises geographic distance from the user, display dimensions, file type popularity, destination page quality, or a combination thereof, and
wherein the second set of sorting criteria is different from the first set of sorting criteria.

19. The method of claim 15,
wherein the first set of sorting criteria comprises a combination of a primary sorting criterion associated with a primary weighting factor and a secondary sorting criterion associated with a secondary weighting factor, and
wherein the primary weighting factor is greater than the secondary weighting factor.

20. The method of claim 15,
wherein the first set of sorting criteria comprises a combination of a first sorting criterion associated with a first weighting factor and a second sorting criterion associated with a second weighting factor, and
wherein the user may assign a desired value to the first weighting factor and the second weighting factor.
